(19) United States
(12) Patent Application Publication
(10) Pub. No.: US 2024/0054554 A1
(43) Pub. Date: Feb. 15, 2024

(54) Sensor matrix for rider monitoring

(71) Applicant: Reby Inc., Walnut, CA (US)

(72) Inventors: Ricard Comas Xanco, Tordera (ES); Elisabet Bayo Puxan, Barcelona (ES); Julio Gonzalez Lopez, Igualada (ES); Akash Kadechkar, Barcelona (ES); Xiaolei Song, Barcelona (ES); Eugeni Llagostera Saltor, Barcelona (ES)

(21) Appl. No.: 17/819,316

(22) Filed: Aug. 12, 2022

(51) Int. Cl. G06Q 30/06; G08B 21/18; B62J 45/41

(52) U.S. Cl. CPC G06Q 30/0645; G08B 21/18; B62J 45/41

(57) ABSTRACT

A system and method for rider profiling for lightweight vehicles is disclosed herein. The system comprises a lightweight vehicle actuating unit. Load-cells are configured on a deck of the lightweight vehicle for sensing and measuring load acting thereupon for generating a measurement signal. A pressure-pattern collection unit receives the measurement signal to identify and process a load pattern acting on the deck to generate a pressure-pattern signal. A learning model receives the pressure-pattern signal for processing to obtain information associated with a pose of the rider. A riding control is coupled to a riding control database and configured to unit receive the information associated with the pose from the learning model for determining at least one instance of rule violation and computing a decision based on the at least one instance of rule violation.

### FIELD OF THE INVENTION

The present disclosure generally relates to urban mobility, and more particularly, to lightweight vehicles, such as kick scooters. In particular, the present disclosure relates to a method and system for rider profiling in kick scooters.

### BACKGROUND OF THE INVENTION

Kick scooters are a good vehicle to move around the city. Typically, kick scooters are configured to propel via a pushing force applied by the foot of a rider on the ground, while the other foot of the rider is placed on a deck of the scooter. However, in recent times, electrically powered scooters have been developed in the art. These scooters are designed as individual vehicles, which means they can accommodate only a rider thereon and no passengers.

However, as a recreational experience, some riders tend to embark upon riding the scooter with a passenger. A disadvantageous aspect of such a matter is that it may lead to the failure of the scooter body, which is clearly designed to hold a certain maximum amount of weight thereon. Furthermore, if more than one person does use the scooter, there is a strong probability of the battery running out much earlier because the motor needs more power to move the scooter. In the worst-case scenario, the scooter will likely not be able to run on an uphill road.

It is to be noted that some technologies have been developed in the art for finding out the number of passengers on-board a vehicle, wherein such technologies involve the usage of video camera or single scales provided on the seat of such vehicles. However, such technologies are specifically designed for two wheeled or four wheeled motor vehicles and are not applicable for the specific application of kick scooters.

There is a need for a system and method for rider profiling, wherein the system and the method are designed to detect the number of people on the lightweight vehicle, riding mannerisms, and some other useful ride parameters associated with the vehicle.

### SUMMARY OF THE INVENTION

The present disclosure envisages a system for rider profiling for lightweight vehicles, such as scooters. For example, in scooter embodiments the system comprises a scooter engine actuating unit. A plurality of load cells is configured on a deck of the scooter for sensing and measuring a load acting upon the deck for generating a measurement signal. A scooter controller is configured on the scooter, where the scooter controller comprises a passenger pose-detection module for detecting a pose of a rider present on the deck of the scooter. The passenger pose-detection module comprises a pressure pattern collection unit configured to receive the measurement signal from the plurality of load cells. The pressure pattern collection unit is configured to identify and process a load pattern acting on the deck based on the measurement signal for generating a pressure pattern signal. A learning model is communicatively coupled to the pressure pattern collection unit for receiving the pressure pattern signal and detecting a pose of a rider onboard the scooter. A riding control unit is coupled to the learning model and a riding profile database. The riding control unit is configured to receive information of the pose from the learning model and compare the pose of the rider with a profile data of the rider; determine based on the pose and pressure pattern signal at least one instance of rule violation; and compute a decision based on the at least one instance of rule violation.

In an alternative embodiment, the system further comprises a central renting service server communicatively coupled to the riding control unit for receiving the decision from the riding control unit and transmitting the decision to a user smart device.

In an alternative embodiment, the at least one instance of rule violation includes usage of the scooter using one leg, boarding of more than one passenger on the scooter, discrepancy between a stored pressure pattern for a user stored in the riding profile database and an obtained pressure pattern for the user, and pushing of the scooter.

In an alternative embodiment, the decision includes at least one of stopping operation of the scooter, recording forensic data for penalties computation, and generating and sending an alert to a user smart device, wherein the alert is one of a ride-associated information and a remedial action suggestion for addressing the at least one instance of rule violation.

In an alternative embodiment, the learning model is at least one of machine learning model, a neural network, and a deep learning model.

In an alternative embodiment, the system further comprises a protective layer provided on the deck, the protective layer configured to provide protection to the plurality of load cells disposed on the deck and below the protective layer.

In an alternative embodiment, the stopping of the operation of the scooter is performed by the scooter engine actuating unit, where the scooter engine actuating unit controls the operation of an electric motor of the scooter and downregulates the speed of the scooter.

The present disclosure also envisages a method for rider profiling for scooters. The method comprises actuating a scooter engine, via a scooter engine actuating unit configured on the scooter, for facilitating starting and stopping operation of the scooter; providing a plurality of load cells on a deck of the scooter for sensing and measuring a load acting upon the deck for generating a measurement signal; detecting, via a passenger pose-detection module, a pose of a rider present on the deck of the scooter, wherein the step of detecting further comprises: receiving, via a pressure pattern collection unit, the measurement signal from the plurality of load cells, for identifying and processing a load pattern acting on the deck based on the measurement signal for generating a pressure pattern signal; and receiving the pressure pattern signal, via a learning model, and detecting a pose of a rider onboard the scooter; receiving, via a riding control unit coupled to the learning model and a riding profile database, information of the pose from the learning model and comparing the pose of the rider with a profile data of the rider; determining, via the riding control unit, based on the pose and pressure pattern signal at least one instance of rule violation; and computing, via the riding control unit, a decision based on the at least one instance of rule violation.

In an alternative embodiment, the method further comprises receiving the decision from the riding control unit at a central renting service server for transmitting the decision to a user smart device.

In an alternative embodiment, the at least one instance of rule violation includes usage of the scooter using one leg, boarding of more than one passenger on the scooter, discrepancy between a stored pressure pattern for a user stored in the riding profile database and an obtained pressure pattern for the user, and pushing of the scooter.

In an alternative embodiment, the decision includes at least one of stopping operation of the scooter, recording forensic data for penalties computation, and generating and sending an alert to a user smart device, wherein the alert is one of a ride-associated information and a remedial action suggestion for addressing the at least one instance of rule violation.

In an alternative embodiment, the learning model is at least one of machine learning model, a neural network, and a deep learning model.

In an alternative embodiment, the method further comprises providing a protective layer on the deck to provide protection to the plurality of load cells disposed on the deck and below the protective layer.

In an alternative embodiment, the stopping of the operation of the scooter is performed by the scooter engine actuating unit, where the scooter engine actuating unit controls the operation of an electric motor of the scooter and downregulates the speed of the scooter.

In various embodiments, the term scooter includes kick scooters, kick scooters with some form of power assistance, and fully electric scooters.

In alternative embodiments, the system and method are implemented for lightweight vehicles generally. Examples of lightweight vehicles include scooters such as kick scooters, kick scooters with some form of power assistance, and fully electric scooters. Lightweight vehicles also include bicycles, motorbikes, mopeds, and any other wheeled vehicle or Light Electric Vehicle (LEV).

### DESCRIPTION OF THE DRAWINGS

FIG. 1A through FIG. 1C illustrate a schematic diagram depicting different ride conditions of a scooter.

FIG. 2 illustrates a schematic diagram depicting an arrangement of a plurality of load cells on a deck of the scooter, in accordance with an embodiment of the present disclosure.

FIG. 3 illustrates a block diagram of a system for rider profiling in kick scooters, in accordance with an embodiment of the present disclosure.

FIG. 4 illustrates a block diagram of a method for rider profiling in kick scooters, in accordance with an embodiment of the present disclosure.

FIG. 5 illustrates an exemplary implementation of the method for rider profiling in kick scooters, in accordance with an embodiment of the present disclosure.

### DETAILED DESCRIPTION

Lightweight vehicles, such as kick scooters, are an excellent and convenient urban mobility solution. Conventionally, kick scooters were configured to be propelled via the user's feet, wherein one foot of the user was supported on the deck, while the other foot of the user was used to push the scooter forward. However, in recent times, electric kick scooters have been developed. These electric scooters include an electric motor and a battery for propulsion. For such vehicles, monitoring of the number of passengers and consequently the weight of the one or more passengers on the scooter is required for battery estimation. To this end, the present subject matter envisages a system and method for rider profiling in lightweight vehicles.

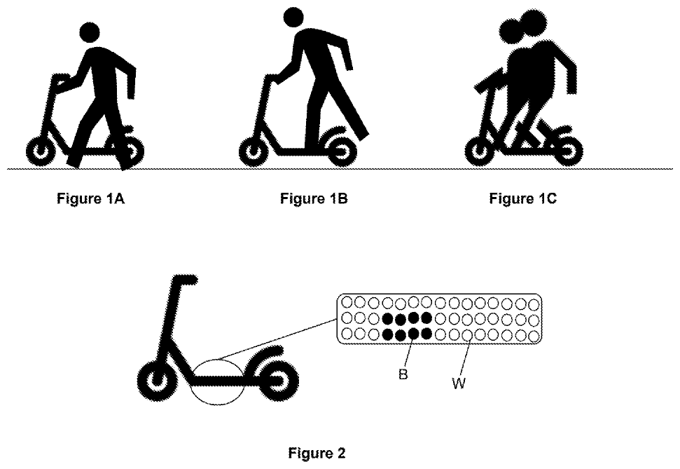

In accordance with one exemplary embodiment of the present disclosure, the system and method include detecting the pose of the rider during the ride. In one embodiment, such a detection can be performed by use of a machine learning model. The machine learning model is trained on a set of datasets, each of which is obtained by recording readings from a plurality of load cells, configured on a deck of a kick scooter, during the process of using the scooter. In accordance with one embodiment, data is collected when the rider is pushing the scooter as illustrated in FIG. 1A (possibly in no-ride zones), when riding a single passenger in various stances and postures as illustrated in FIG. 1B, and when driving with two or three passengers as illustrated in FIG. 1C. In one embodiment, the data can also be collected for each of the cases when driving at different speeds and surfaces because uneven surfaces can create pressure pulses on the plurality of load cells, as illustrated in FIG. 2. More specifically, in FIG. 2, the load cells on which pressure is acting are depicted in black color ‘B’, while the ones depicted in white ‘W’ are those load cells that have no load acting thereupon. It is to be noted that the combination of load cells B and W on the deck of the scooter define a pressure pattern. In one embodiment, training can be performed on a different array configurations of load cells to subsequently determine the optimal parameters of one cell such as sensitivity, maximum load, and dimensions for determining the most optimal arrangement of the load cells on the deck of the scooter. In one embodiment, the training can also be performed to determine the number of load cells and their location relative to each other on the deck of the scooter. More specifically, different load cell distribution configurations, such as equidistant distribution or denser accumulation of cells along the axis of the base of the scooter, are also studied in such training. In one embodiment, during such training, the data is tagged, wherein each tag characterises different parameters such as the number of passengers, their weight, height, posture, speed, type of road surface, and so on. In one embodiment, the dataset collected from one implementation of the load cell array is used to train a machine learning model that classifies the position of a passenger or several passengers on a scooter with acceptable accuracy, regardless of the speed of movement and traffic conditions.

The system and method of the present disclosure also facilitate detection of various ride-associated parameters such as number of passengers, weight of passengers, battery status, and so on in real time while the scooter is being ridden by the rider. From the different ride-associated parameters, at least one instance of rule violation is computed. In one embodiment, the at least one instance of rule violation includes usage of the scooter using one leg, boarding of more than one passenger on the scooter, discrepancy between a stored pressure pattern for a user stored in a riding profile database and an obtained pressure pattern for the user, and pushing of the scooter. In an embodiment, when the user starts the ride, the electric scooter turns on and starts reading the values from the plurality of load cells. According to one aspect, while the passenger has not got on the scooter or has not yet begun to move, the reading of signals occurs at a discharged frequency or from a selected group of cells to detect the landing of passengers or to determine that the scooter is being pushed. Accordingly, when the scooter starts moving, the values from the plurality of load cells are read at an increased frequency to determine the pressure pattern and detect a violation of rules for using the scooter at the very beginning of the ride more accurately. In one embodiment, based on the data collected over a certain period (for example, from one measurement to one thousand measurements depending on the reading frequency, or from one microsecond to one second), a pressure pattern is determined that characterises the parameters and position of the passenger. In another aspect, when braking and accelerating, reading changes in the pressure pattern can also be used to determine other characteristics of the passenger, such as the centre of gravity or estimated height. According to one aspect of the present invention, in order not to waste a large amount of computing resources, the frequency and volume of processed measurements are reduced to optimal values. In a practical scenario, detecting the position of the feet by one measurement may not be accurate enough, because the scooter at the instant of measurement can run into a bump or the passenger can rearrange their legs. Several measurements are read, and an average pressure pattern is built, and values that go beyond the median or average values are ignored as noise.

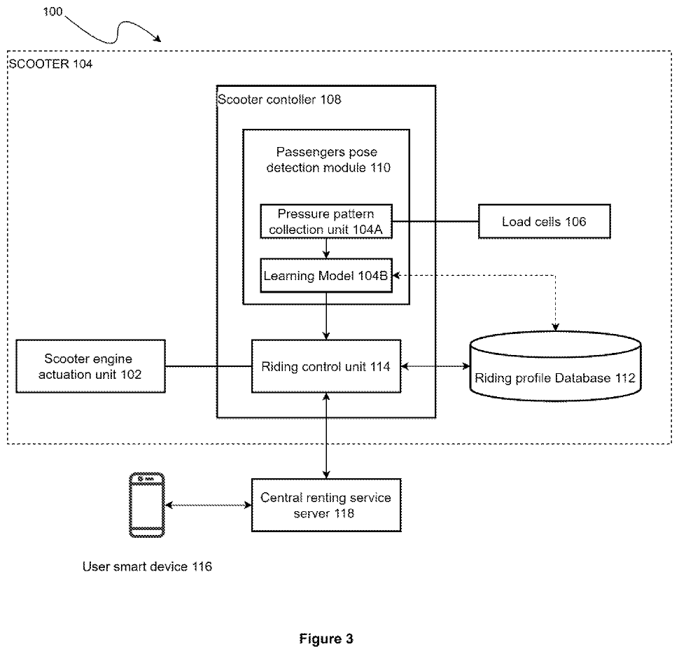

FIG. 3 illustrates a block diagram of a system for rider profiling in kick scooters 100 (hereinafter interchangeably referred to as system 100), in accordance with an embodiment of the present disclosure. The system 100 comprises a scooter engine actuating unit 102 configured on a scooter 104 for facilitating starting and stopping operation of the scooter 104. In an embodiment, the starting and stopping the operation of the scooter 104 includes starting and stopping of the propulsion means of the scooter 104, which may be an electric motor in accordance with one embodiment, along with the starting and stopping of all the associated peripherals of the scooter 100. In an embodiment, the scooter engine actuating unit is an electromotor controller for controlling operation of an electric motor of the scooter.

The system 100 further comprises a plurality of load cells 106 configured on a deck of the scooter 104 for sensing and measuring a load acting upon the deck for generating a measurement signal. A scooter controller 108 is configured on the scooter 108, wherein the scooter controller 108 comprises a passenger pose-detection module 110. The passenger pose-detection module 110 is configured for detecting a pose of a rider present on the deck of the scooter. The passenger pose-detection module 110 comprises a pressure pattern collection unit 110A configured to receive the measurement signal from the plurality of load cells 106. The pressure pattern collection unit 110A is configured to identify and process a load pattern acting on the deck based on the measurement signal to generate a pressure pattern signal.

According to one aspect, while the passenger has not got on the scooter 104 or has not yet begun to move, the reading of measurement signals occurs at a discharged frequency or from a selected group of load cells 106 to detect the landing of passengers or to determine that the scooter 104 is being pushed. Accordingly, when the scooter starts moving, the values from the plurality of load cells 106 are read by the pressure pattern collection unit 110A at an increased frequency to determine the pressure pattern and detect a violation of rules for using the scooter 104 at the very beginning of the journey more accurately. In a practical scenario, detecting the position of the feet by one measurement (one measurement signal) may not be accurate enough, because the scooter 104 at this moment can run into a bump or the passenger can rearrange their legs. Several measurements of the measurement signal are read, and an average pressure pattern is built by the pressure pattern collection unit 110A, and values that go beyond the median or average values are ignored as noise.

The passenger pose-detection module 110 further comprises a learning model 110B that is communicatively coupled to the pressure pattern collection unit 110A for receiving the pressure pattern signal generated at the pressure pattern collection unit 110A. The learning model 110B is communicatively coupled to a riding profile database 112 and configured for processing the pressure pattern signal for obtaining information associated with the pose of the rider based on the information from the pressure pattern signal and the riding profile database 112. In one embodiment, based on the data collected over a certain period, for example, from one measurement to one thousand measurements of measurement signal, depending on the reading frequency, or from one microsecond to one second, a pressure pattern can be determined by the pressure pattern collection unit 110A for generation of the pressure pattern signal, which is then received by the learning model 110B. In one embodiment, the learning model 110B can characterise the parameters and position of the passenger based on the pressure pattern signal. In another aspect, when braking and accelerating, the changes in the pressure pattern signal happening in real time while the rider is riding the scooter 104, can also be used by the learning model 110B to determine other characteristics of the passenger, such as the centre of gravity or estimated height. In one embodiment, the learning model 110B is a machine learning pose-detection model, and the riding profile database 112 is also a machine learning database. In an alternative embodiment, the learning model 110B is at least one of machine learning models, a neural network, and a deep learning model.

The system 100 further comprises a riding control unit 114. The riding control unit 114 is coupled to the learning model 110B and the riding profile database. The riding control unit 114 is configured to receive information of the pose from the learning model and compare the pose of the rider with a profile data of the rider; determine based on the pose and pressure pattern signal at least one instance of rule violation; and computing a decision based on the at least one instance of rule violation. From the different poses and ride-associated parameters, at least one instance of rule violation is computed. In one embodiment, the at least one instance of rule violation includes usage of the scooter using one leg, boarding of more than one passenger on the scooter, discrepancy between a stored pressure pattern for a user stored in a riding profile database and an obtained pressure pattern for the user, and pushing of the scooter. In one embodiment, the decision includes at least one of stopping operation of the scooter, recording forensic data for penalties computation, and generating and sending an alert to a user smart device, wherein the alert is one of a ride-associated information and a remedial action suggestion for addressing the at least one instance of rule violation. In one embodiment, the stopping of the operation of the scooter is performed by the scooter engine actuating unit 102, where the scooter engine actuating unit 102 controls the operation of an electric motor of the scooter and downregulates the speed of the scooter.

In one implementation, the number of passengers aboard the scooter 104 can be computed using the pressure pattern signal. In another embodiment, the number of passengers aboard the scooter 104 can be computed by detecting the number of hands placed on a handlebar of the scooter 104 via touch sensors that can be installed thereupon. In another embodiment, the scooter 104 can include one or more image capturing units, wherein such image capturing units can allow for detection of the number of people aboard the scooter 104. In one embodiment, a combination image capturing units and load cells can allow for accurately detecting the number of passengers onboard the scooter. In a scenario where the riding control unit 114 detects more than two passengers aboard the scooter 104, the riding control unit 114 can compute the decision to stop the ride of the scooter 104. In an alternative embodiment, the riding control unit 114 can generate an alert to suggest a remedial action to the user, wherein the remedial action can be to ask the user to restart the ride while having only one person board the deck of the scooter 104. In an embodiment, a central renting service server 118 is communicatively coupled to the riding control unit 114 for receiving the decision from the riding control unit and transmitting the decision to a user smart device.

In an embodiment, the system 100 further comprises a protective layer provided on the deck of the scooter. The protective layer is configured to provide protection to the plurality of load cells 106 disposed on the deck and below the protective layer. In one embodiment, the protective layer has a small thickness and a high endurance.

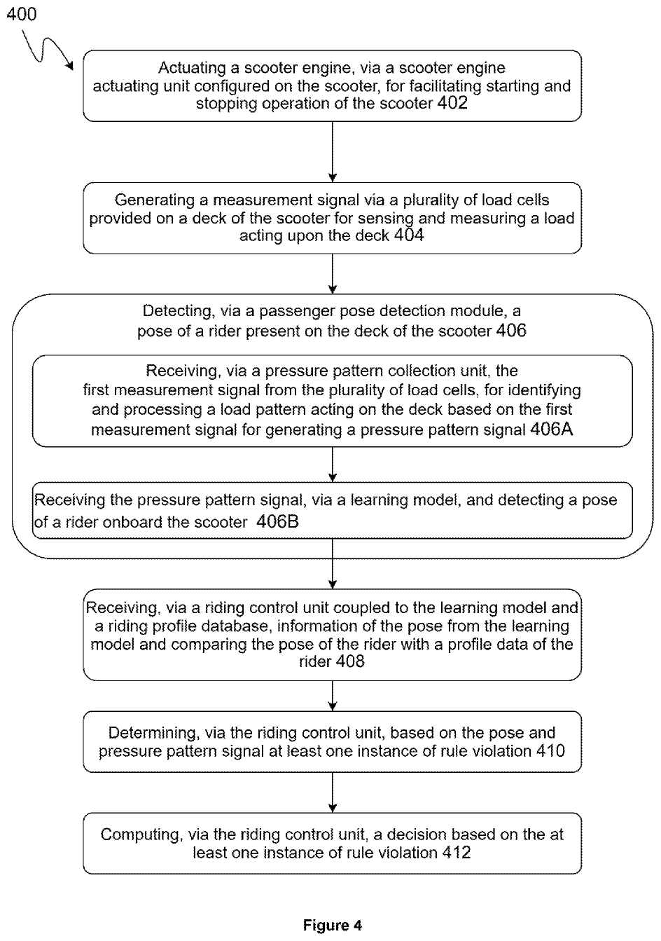

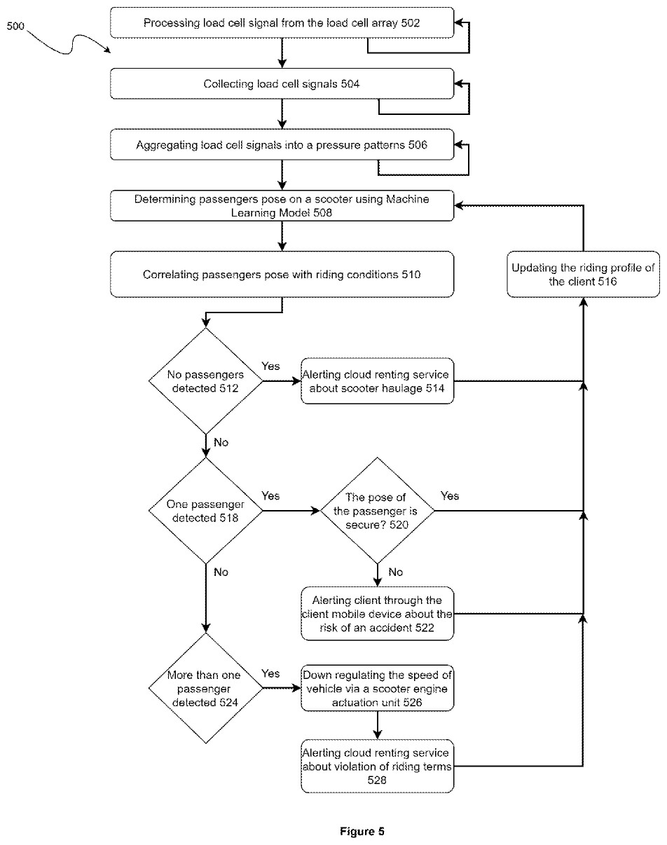

FIG. 4 shows a block diagram depicting a method for rider profiling for scooters (hereinafter referred to as method 400), in accordance with an embodiment of the present subject matter. The order in which the method 400 is described is not intended to be construed as a limitation, and any number of the described method blocks can be combined in any order to implement the method or similar alternative methods. Additionally, individual blocks can be deleted from the method without departing from the spirit and scope of the subject matter described herein. Furthermore, the method can be implemented in any suitable hardware, software, firmware, or combination thereof.

At block 402, the method 400 comprises actuating a scooter engine, via a scooter engine actuating unit 102 configured on the scooter 104, for facilitating starting and stopping operation of the scooter. In an embodiment, the starting and stopping the operation of the scooter 104 includes starting and stopping of the propulsion means of the scooter 104, which may be an electric motor in accordance with one embodiment, along with the starting and stopping of all the associated peripherals of the scooter 100. In an embodiment, the scooter engine actuating unit is an electromotor controller for controlling operation of an electric motor of the scooter.

At block 404, the method 400 includes generating a measurement signal via plurality of load cells 106 provided on a deck of the scooter 104 for sensing and measuring any load acting upon the deck. In accordance with one embodiment, a scooter controller 108 is configured on the scooter 108, wherein the scooter controller 108 comprises a passenger pose-detection module 110. The passenger pose-detection module 110 is configured for detecting a pose of a rider present on the deck of the scooter.

At block 406, the method 400 comprises detecting, via the passenger pose-detection module 110, a pose of a rider present on the deck of the scooter. At block 406A of the step 406 of detecting, the method 400 further comprises receiving, via a pressure pattern collection unit 110A, the measurement signal from the plurality of load cells 106, for identifying and processing a load pattern acting on the deck based on the measurement signal for generating a pressure pattern signal. According to one aspect, while the passenger has not got on the scooter 104 or has not yet begun to move, the reading of measurement signals occurs at a discharged frequency or from a selected group of load cells 106 to detect the landing of passengers or to determine that the scooter 104 is being pushed. Accordingly, when the scooter starts moving, the values from the plurality of load cells 106 are read by the pressure pattern collection unit 110A at an increased frequency to determine the pressure pattern and detect a violation of rules for using the scooter 104 at the very beginning of the journey more accurately. In a practical scenario, detecting the position of the feet by one measurement (one measurement signal) may not be accurate enough, because the scooter 104 at this moment can run into a bump or the passenger can rearrange their legs. Several measurements of the measurement signal are read, and an average pressure pattern is built by the pressure pattern collection unit 110A, and values that go beyond the median or average values are ignored as noise.

At block 406B of the step 406, the method 400 comprises receiving the pressure pattern signal, via a learning model 110B, wherein the learning model 110B is communicatively coupled to a riding profile database 112 and configured for processing the pressure pattern signal for obtaining information associated with a pose of the rider on the scooter.

In one embodiment, based on the data collected over a certain period, for example, from one measurement to one thousand measurements of measurement signal, depending on the reading frequency, or from one microsecond to one second, a pressure pattern can be determined by the pressure pattern collection unit 110A for generation of the pressure pattern signal, which is then received by the learning model 110B. In one embodiment, the learning model 110B can characterise the parameters and position of the passenger based on the pressure pattern signal. In another aspect, when braking and accelerating, the changes in the pressure pattern signal happening in real time while the rider is riding the scooter 104, can also be used by the learning model 110B to determine other characteristics of the passenger, such as the centre of gravity or estimated height. In one embodiment, the learning model 110B is a machine learning pose-detection model, and the riding profile database 112 is also a machine learning database. In an alternative embodiment, the learning model 110B is at least one of machine learning model, a neural network, and a deep learning model.

At block 408, the method 400 includes receiving, via a riding control unit 114 coupled to the learning model 110B and the riding profile database 112, information of the pose from the learning model 110B and comparing the pose of the rider with a profile data of the rider from the riding profile database 112.

At block 410, the method 400 includes determining, via the riding control unit 114, based on the pose and pressure pattern signal at least one instance of rule violation. In one embodiment, the at least one instance of rule violation includes usage of the scooter using one leg, boarding of more than one passenger on the scooter, discrepancy between a stored pressure pattern for a user stored in the riding profile database and an obtained pressure pattern for the user, and pushing of the scooter.

At block 412, method 400 includes computing, via the riding control unit 114, a decision based on at least one instance of rule violation. In one embodiment, the decision includes at least one of stopping operation of the scooter, recording forensic data for penalties computation, and generating and sending an alert to a user smart device, wherein the alert is one of a ride-associated information and a remedial action suggestion for addressing the at least one instance of rule violation. In one embodiment, the stopping of the operation of the scooter is performed by the scooter engine actuating unit 102, where the scooter engine actuating unit 102 controls the operation of an electric motor of the scooter and downregulates the speed of the scooter.

In an embodiment, the method 400 further comprises transmitting the decision computed by the riding control unit to the user smart device.

FIG. 5 illustrates an exemplary implementation 500 of the method for rider profiling in kick scooters, in accordance with an embodiment of the present disclosure. At block 502, the implementation 500 includes generating load cell signal from the load cells 106. In one embodiment, the signal from the load cells is the measurement signal that is received and processed further by the passenger pose-detection module 110.

At block 504, the implementation 500 includes collecting load cell signals. In an embodiment, the load cell signals are measurement signals that are received by the pressure pattern collection unit 110A of the passenger pose-detection module 110.

At block 506, the implementation 500 includes aggregating load cell signals into a pressure pattern. More specifically, the pressure pattern collection unit 110A processes the measurement signals to generate the pressure pattern signals.

At block 508, the implementation 500 includes determining passengers pose on a scooter using learning model 110B. At block 510, the implementation 500 includes correlating passengers pose with riding conditions. More specifically, the pressure pattern signals are analysed in real time to not only detect the passenger's pose but also many other parameters about the ride. In one embodiment, this step is performed in real time. In one embodiment, the other parameters that are computed using the pressure pattern signals include the number of passengers onboard the scooter, the height and weight of the passengers, the riding pose of the passengers, and so on.

At block 512, the implementation 500 includes a querying if no passengers are detected. If no passenger is detected, the implementation 500 proceeds to block 514, which includes alerting cloud renting service server 118 about scooter haulage, wherein this information is also then used at block 516 for updating the riding profile of the client. Such an update allows the riding profile database 112 to be regularly updated with respect to the latest activities of the users on the platform.

If one or more passengers is detected, then implementation 500 proceeds to block 518 when one passenger is detected. In such a case, where one passenger is detected, the implementation 500 then proceeds to block 520 to detect if the pose of the passenger is secure. If the pose is found to be secure, then the implementation proceeds to block 516 which involves updating the riding profile database.

If the pose is detected to be not secure, the implementation 500 proceeds to block 522 that includes alerting the client through the client mobile device about the risk of an accident, and then the implementation proceeds to block 516 which involves updating the riding profile database. In an embodiment, the decision of judging if the pose is secure or not is performed by the riding control unit 114.

If more than one passenger is detected to be on board the scooter, then the implementation directly moves to block 524 from block 518, wherein at block 524 the implementation 500 includes checking if more than one passenger is detected. If more than one passenger is detected, the implementation moves to block 526 which includes regulating the speed of the vehicle via the scooter engine actuation unit. In an embodiment, the scooter engine actuating unit is an electromotor controller for controlling operation of an electric motor of the scooter. The reduction of speed eventually proceeds to stop the scooter completely. Once the scooter is completely stopped, the implementation 500 moves on to block 528, which includes alerting cloud renting service servers about violation of riding terms, after which an alert with a remedial action suggestion can be sent to the user smart device. After alerting the central server, the implementation proceeds to block 516 which involves updating the riding profile database.

As can be seen from the above, the riding profile database can be updated at each step for updating the database about the activities of the user. The central server can then use this information to classify the users based on their activities, wherein after a pre-defined number of red flags are raised by a certain user, they can be blacklisted from using the service again.

1. A system for rider profiling for lightweight vehicles, the system comprising:
a lightweight vehicle engine actuating unit;
a plurality of load cells configured on a deck of the lightweight vehicle for sensing and measuring a load acting upon the deck for generating a measurement signal;
a lightweight vehicle controller configured on the lightweight vehicle, the lightweight vehicle controller comprising:
a passenger pose-detection module for detecting a pose of a rider present on the deck of the lightweight vehicle, the passenger pose-detection module comprising:
a pressure pattern collection unit configured to receive the measurement signal from the plurality of load cells, the pressure pattern collection unit configured to identify and process a load pattern acting on the deck based on the measurement signal for generating a pressure pattern signal;
a learning model communicatively coupled to the pressure pattern collection unit to receive the pressure pattern signal and detect a pose of a rider onboard the lightweight vehicle;
a riding control unit coupled to the learning model and a riding profile database, the riding control unit configured to:
receive information of the pose from the learning model and compare the pose of the rider with a profile data of the rider;
determine based on the pose and pressure pattern signal at least one instance of rule violation; and
compute a decision based on at least one instance of the rule violation.

2. The system according to claim 1, wherein the lightweight vehicle is scooter.

3. The system according to claim 1, further comprising a central renting service server communicatively coupled to the riding control unit for receiving the decision from the riding control unit and transmitting the decision to a user smart device.

4. The system according to claim 1, wherein the at least one instance of rule violation includes usage of the lightweight vehicle using one leg, boarding of more than one passenger on the lightweight vehicle, discrepancy between a stored pressure pattern for a user stored in the riding profile database and an obtained pressure pattern for the user, and pushing of the lightweight vehicle.

5. The system according to claim 1, wherein the decision includes at least one of stopping operation of the lightweight vehicle, recording forensic data for penalties computation, and generating and sending an alert to a user smart device, wherein the alert is one of a ride-associated information and a remedial action suggestion for addressing the at least one instance of rule violation.

6. The system according to claim 1, wherein the learning model is at least one of machine learning model, a neural network, and a deep learning model.

7. The system according to claim 1, further comprising a protective layer provided on the deck, the protective layer configured to provide protection to the plurality of load cells disposed on the deck and below the protective layer.

8. The system according to claim 4, wherein the stopping of the operation of the lightweight vehicle is performed by the lightweight vehicle engine actuating unit, wherein the lightweight vehicle engine actuating unit controls the operation of an electric motor of the lightweight vehicle and downregulates the speed of the lightweight vehicle.

9. A method for rider profiling for lightweight vehicles, the method comprising:
actuating a lightweight vehicle engine, via a lightweight vehicle engine actuating unit configured on the lightweight vehicle, for facilitating starting and stopping operation of the lightweight vehicle;
generating a measurement signal via a plurality of load cells provided on a deck of the lightweight vehicle for sensing and measuring a load acting upon the deck;
detecting, via a passenger pose-detection module, a pose of a rider present on the deck of the lightweight vehicle, wherein the step of detecting further comprises:
receiving, via a pressure pattern collection unit, the measurement signal from the plurality of load cells, for identifying and processing a load pattern acting on the deck based on the measurement signal for generating a pressure pattern signal; and
receiving the pressure pattern signal, via a learning model, and detecting a pose of a rider onboard the lightweight vehicle;
receiving, via a riding control unit coupled to the learning model and a riding profile database, information of the pose from the learning model and comparing the pose of the rider with a profile data of the rider;
determining, via the riding control unit, based on the pose and pressure pattern signal at least one instance of rule violation; and
computing, via the riding control unit, a decision based on at least one instance of the rule violation.

10. The method according to claim 9, wherein the lightweight vehicle is a scooter.

11. The method according to claim 9, further comprising the step of receiving the decision from the riding control unit at a central renting service server for transmitting the decision to a user smart device.

12. The method according to claim 9, wherein the at least one instance of rule violation includes usage of the lightweight vehicle using one leg, boarding of more than one passenger on the lightweight vehicle, discrepancy between a stored pressure pattern for a user stored in the riding profile database and an obtained pressure pattern for the user, and pushing of the lightweight vehicle.

13. The method according to claim 9, wherein the decision includes at least one of stopping operation of the lightweight vehicle, recording forensic data for penalties computation, and generating and sending an alert to a user smart device, wherein the alert is one of a ride-associated information and a remedial action suggestion for addressing the at least one instance of rule violation.

14. The method according to claim 9, wherein the learning model is at least one of machine learning model, a neural network, and a deep learning model.

13. The method according to claim 9, further comprising providing a protective layer on the deck to provide protection to the plurality of load cells disposed on the deck and below the protective layer.

14. The method according to claim 12, wherein the stopping of the operation of the lightweight vehicle is performed by the lightweight vehicle engine actuating unit, wherein the lightweight vehicle engine actuating unit controls the operation of an electric motor of the lightweight vehicle and downregulates the speed of the lightweight vehicle.
